(19) United States
(12) Patent Application Publication
(10) Pub. No.: US 2014/0349521 A1
(43) Pub. Date: Nov. 27, 2014

(54) JOINT TERMINAL AND JOINT CONNECTOR

(71) Applicant: YAZAKI CORPORATION, Tokyo (JP)

(72) Inventor: Nobuyuki SAKAMOTO, Shizuoka (JP)

(21) Appl. No.: 14/457,444

(22) Filed: Aug. 12, 2014

Related U.S. Application Data
(63) Continuation of application No. PCT/JP2012/008247, filed on Dec. 25, 2012.

(30) Foreign Application Priority Data
Feb. 16, 2012 (JP) 2012-031308

(51) Int. Cl. H01R 4/18; H01R 13/514

(52) U.S. Cl. CPC H01R 4/18; H01R 13/514
USPC 439/626; 439/878

(57) ABSTRACT

A joint terminal is to be used in a connector housing in a plurality. The joint terminal includes a wire-crimping portion, a terminal body to be housed in a terminal chamber of the connector housing (the terminal body includes a bottom wall and a pair of sidewalls perpendicularly extended from both side ends of the bottom wall, respectively) and a pair of first and second contact portions laterally extended outward from the pair of sidewalls of the terminal body, respectively. In the joint terminal, a pair of front walls is perpendicularly extended from front ends of the sidewalls toward each other so that end edges of the front walls face to each other. The sidewalls 14 are bent, at a maximum, until the end edges of the front walls contact with each other. Therefore, the joint terminal can become structurally strong.

### CROSS-REFERENCE TO RELATED APPLICATIONS

The present application is a Continuation Application of PCT International Application No. PCT/JP2012/008247 (filed on Dec. 25, 2012), which is based upon and claims the benefit of priority from Japanese Patent Application No. 2012-31308 (filed on Feb. 16, 2012), the entire contents of which are incorporated herein with reference.

### BACKGROUND OF THE INVENTION

1. Technical Field

The present invention relates to a joint terminal that is used with a connector housing in a plurality and electrically connected with another neighboring joint terminal (or other neighboring joint terminals) in the connector housing, and to a joint connector including the housing and the joint terminal(s).

2. Background Art

A Patent Literature 1 (Japanese Utility Model Application Laid-Open No. H6-36268) discloses one of prior art joint connectors including joint terminals. As shown in FIGS. 6 and 7, the joint connector 50 includes a connector housing 51, and plural joint terminals 60 housed in the connector housing 51. Note that only one of the joint terminals 60 is shown in FIG. 6, and others of them are not shown in FIG. 6.

The connector housing 51 is provided with plural terminal chambers 53 segmented by partitions 52. A slit 54 is formed on each of the partitions 52.

The joint terminal 60 includes a wire-crimping portion 61 with which a wire W is connected, a terminal body 62 integrally provided with the wire-crimping portion 61, and a pair of contact tabs 63 integrally provided with the terminal body 62. The terminal body 62 is mainly constituted of a bottom wall 62a and a pair of sidewalls 62b. The terminal body 62 is inserted into the terminal chamber 53 and thereby housed in the terminal chamber 53. The contact tabs 63 are bent laterally outward from upper ends of the sidewalls 62b, respectively.

The two contact tabs 63 of the joint terminal 60 are located in the adjacent slits 54, respectively. In a slit 54, a one-side contact tab 63 of a joint terminal 60 contacts with an other-side contact tab 63 of a next joint terminal 60. The contact tabs 63 in the slit 54 are overlapped so as to contact with each other. Therefore, the neighboring joint terminals 60 are electrically contacted with each other.

According to the prior art joint connector 50, the neighboring joint terminals 60 are directly contacts with each other, electrically, so that no additional component is needed for connecting the neighboring joint terminals 60, such as an interposed conductive member and components associated with the conductive member.

### SUMMARY OF INVENTION

However, in the prior art joint terminal(s) 60, the terminal body 62 is made by bending a conductive (metal) plate to form the bottom wall 62a and the pair of sidewalls 62b, and also the pair of contact tabs 63 is made by bending the conductive (metal) plate so as to be extended outward from the sidewalls 62b, respectively. Since an upper plane of the terminal body 62 becomes opened, the terminal body 62 is subject to be structurally weak.

If an external force as indicated by arrows shown in FIG. 7 acts on the terminal body 62 when assembling wire harnesses and so on, the terminal body 62 is subject to be highly-deformed until the sidewalls 62b contact with each other. Namely, the joint terminal 60 is deformed to a plastic deformation range (beyond an elastic deformation range), so that a structure of the joint terminal 60 cannot be maintained.

An object of the present invention provides a joint terminal that is structurally strong, and a joint connector using the joint terminal in a plurality.

A first aspect of the present invention provides a joint terminal that is to be used in a connector housing in a plurality, and includes: a wire-crimping portion with which a wire is connected; a terminal body to be housed in a terminal chamber of the connector housing, the terminal body including a bottom wall and a pair of sidewalls perpendicularly extended from both side ends of the bottom wall, respectively; and a pair of first and second contact portions laterally extended outward from the pair of sidewalls of the terminal body, respectively, wherein a pair of front walls is perpendicularly extended from front ends of the sidewalls toward each other so that end edges of the front walls face to each other.

A second aspect of the present invention provides a joint connector that includes: a housing that includes a plurality of terminal chambers segmented by a plurality of partitions; and at least two neighboring joint terminals that are housed in terminal chambers neighboring among the plurality of terminal chambers, respectively, wherein each of the neighboring joint terminals includes a wire-crimping portion with which a wire is connected, a terminal body housed in a terminal chamber among the plurality of terminal chambers, and a pair of first and second contact portions laterally extended outward from both sides of the terminal body, respectively, the each of the neighboring joint terminals includes a bottom wall and a pair of sidewalls perpendicularly extended from both side ends of the bottom wall, respectively, and the pair of first and second contact portions is extended from the sidewalls, the first contact portion of one of the neighboring joint terminals is electrically contacted with the second contact portion of another of the neighboring joint terminals in a slit among the plurality of slits that is located between the neighboring joint terminals, a pair of front walls of the each of the neighboring joint terminals is perpendicularly extended from front ends of the sidewalls toward each other so that end edges of the front walls face to each other.

According to the above first or second aspect, an external force(s) is applies to the sidewalls of the terminal body, so that the sidewalls are bent, at a maximum, until the end edges of the front walls contact with each other. But the sidewalls are prevented from being bent further. Therefore, the joint terminal can become structurally strong.

In the above first or second aspect, it is preferable that the front walls are formed at the front ends of the sidewalls by bending portions extended from the front ends of the sidewalls, respectively.

In the above first or second aspect, it is also preferable that a supplemental front wall is further formed at a front end of the bottom wall by bending a portion extended from the front end of the bottom wall so that the supplemental front wall closes a front area in a front plane of the terminal body that is not closed by the front walls.

### BRIEF DESCRIPTION OF DRAWINGS

FIG. 1 is a perspective view of a joint terminal and a joint connector according to an embodiment;

FIG. 2 is a cross-sectional view taken along a line II-II shown in FIG. 1;

FIG. 3 is a perspective view of the joint terminal;

FIG. 4 is a front view of the joint terminal;

FIG. 5 is an enlarged perspective view showing a main portion of the joint terminal (viewed from its bottom side);

FIG. 6 is a perspective view of a joint terminal and a joint connector according to a prior art; and

FIG. 7 is an enlarged cross-sectional view showing a main portion of the joint connector in which the joint terminals are housed according to a prior art.

### DESCRIPTION OF EMBODIMENTS

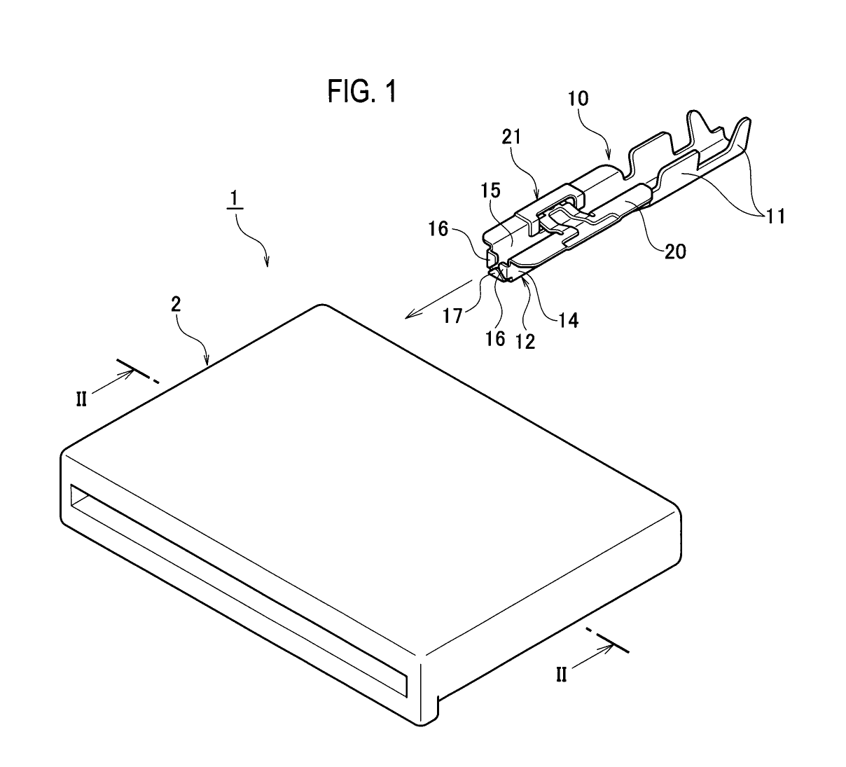

An embodiment of a joint connector and a joint terminal will be explained with reference to FIGS. 1 to 5.

The joint connector 1 includes a non-conductive housing 2, and plural joint terminals 10 housed in the connector housing 2. Note that only one of the joint terminals 10 is shown in FIG. 1 and others of them are not shown in FIG. 1.

The connector housing 2 is provided with plural terminal chambers 4 segmented by partitions 3. A slit 5 is formed on each of the partitions 3. The neighboring terminal chambers 4 are communicated with each other via the slit 5. Lances 6 are integrally formed on the connector housing. The lances 6 are associated with the terminal chambers 4, respectively. The lances 6 are formed as barbed tabs and have pawls protruded from bottoms of the terminal chambers 4, respectively. Each of the lance 6 locks the joint terminal 10 had been inserted into the terminal chamber 4 in order to prevent the joint terminal 10 from being pulled out from the terminal chamber 4.

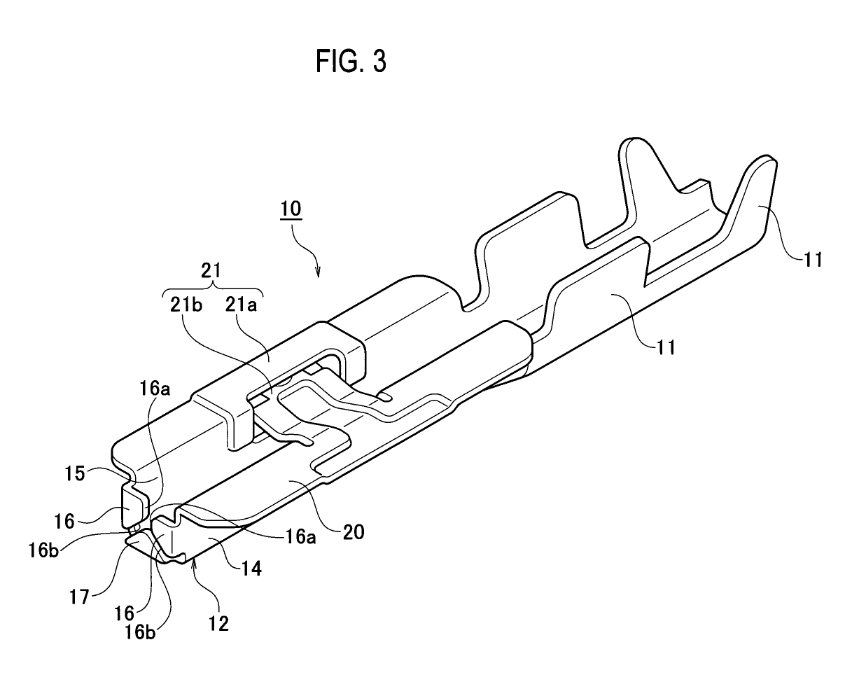

As shown in FIGS. 3 to 5, the joint terminal 10 is formed by bending a conductive (metal) plate having a given dimension. The joint terminal 10 includes a wire-crimping portion 11 to which a wire is to be connected, a terminal body 12 integrally provided with the wire-crimping portion 11, and a pair of a first contact portion 20 and a second contact portion 21 that are integrally provided with the terminal body 12.

The terminal body 12 is constituted of a bottom wall 13, a pair of sidewalls 14 and 15, a pair of front walls 16, and a supplemental front wall 17. The terminal body 12 is inserted into the terminal chamber 4 and thereby housed in the terminal chamber 4. A lance receive hole 13a is formed on the bottom wall 13. The lance receive hole 13a is to be engaged with the above-explained lance 6 formed on the housing 2. The joint terminal 10 is prevented from being pulled out from the terminal chamber 4 due to an engagement of the lance receive hole 13a with the pawl of the lance 6.

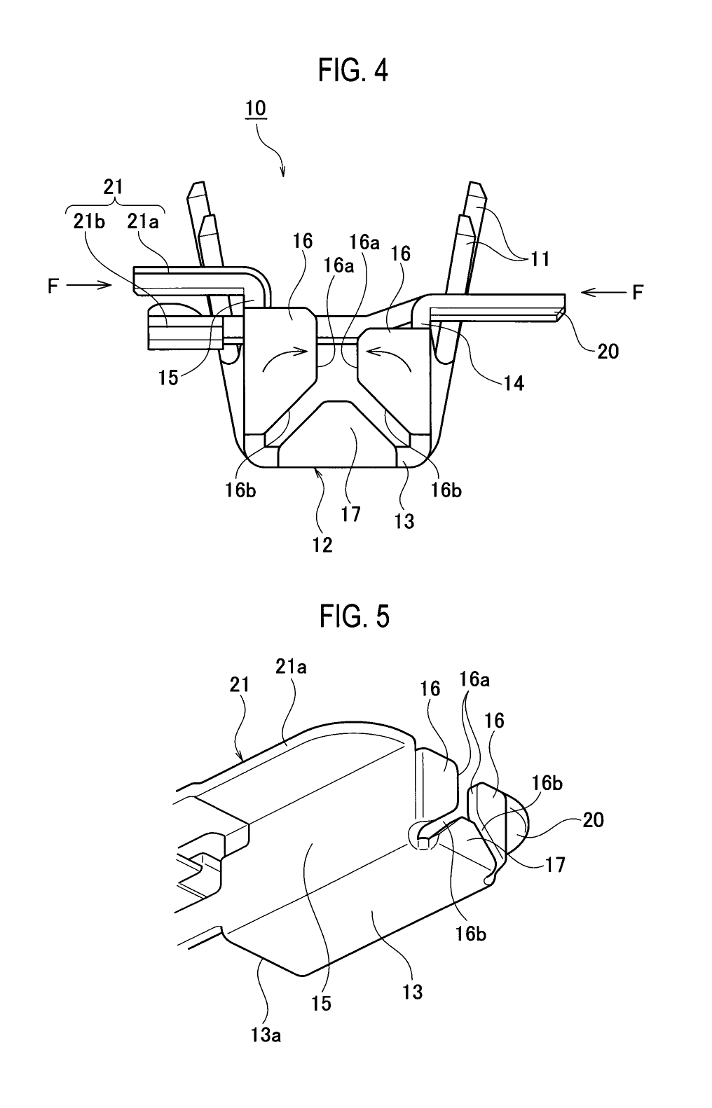

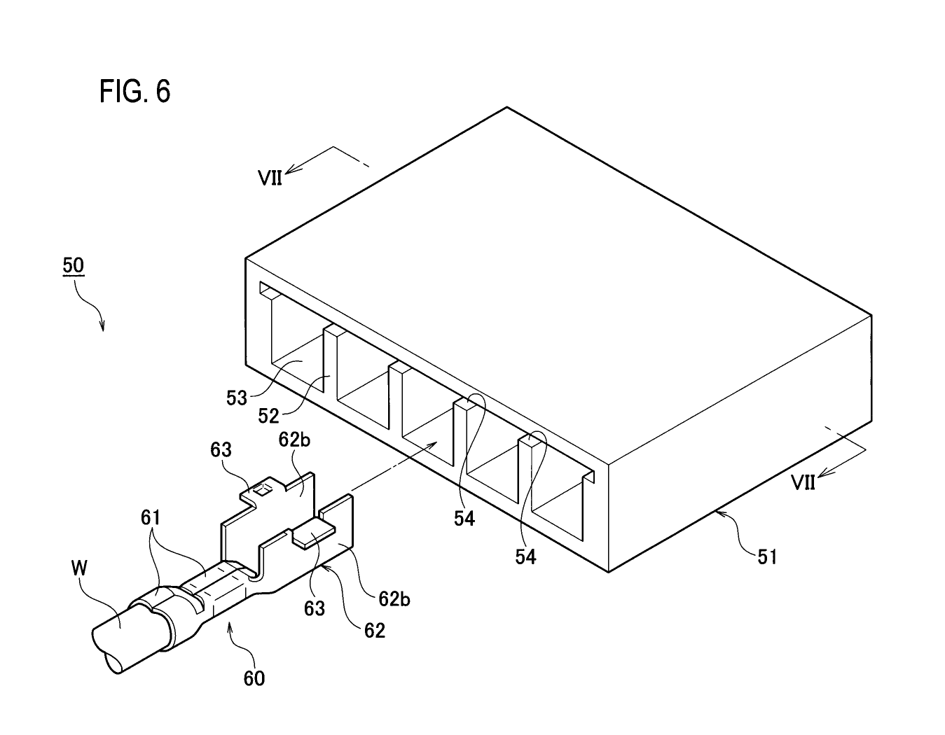

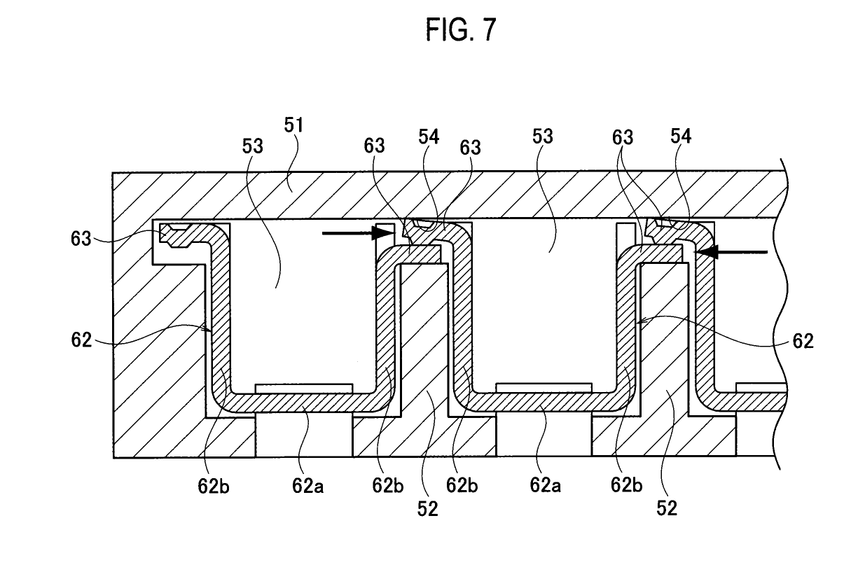

The pair of front walls 16 of the terminal body 12 is bent inward from front ends of the sidewalls 14 and 15, respectively. End edges 16a of the front walls 16 are opposed to each other, and a gap is formed between the end edges 16a. A width of the gap is set so that the sidewalls 14 and 15, when bent until the end edges 16a contact with each other due to an external force(s) F shown in FIG. 4, do not reach to a plastic deformation range, but can remain within an elastic deformation range.

The supplemental front wall 17 of the terminal body 12 is bent inward from a front end of the bottom wall 13. The supplemental front wall 17 closes a front area in a front plane of the terminal body 12 that is not closed by the front walls 16. Note that the supplemental front wall 17 also functions as a stopper for preventing the sidewalls 14 and 15 from being bent excessively by contacting with the front walls 16.

A pair of a first contact portion 20 and a second contact portion 21 is extended laterally outward from both sides of the terminal body 12, respectively. The first contact portion 20 is bent laterally outward from an upper end of the sidewall 14. The second contact portion 21 is constituted of an upper contact tab 21a bent laterally outward from an upper end of the sidewall 15, and a lower contact tab 21b extended from an inner upper edge of the first contact portion 20. A height level of the first contact portion 20 is set in a range between a height level of the upper contact tab 21a and a height level of the lower contact tab 21b (see FIG. 4). The lower contact tab 21b passes through a hole formed on the sidewall 15, so that an end portion of the lower contact tab 21b locates just beneath the upper contact tab 21a. The upper contact tab 21a and the lower contact tab 21b are located parallel and a gap is formed between the upper contact tab 21a and the lower contact tab 21b.

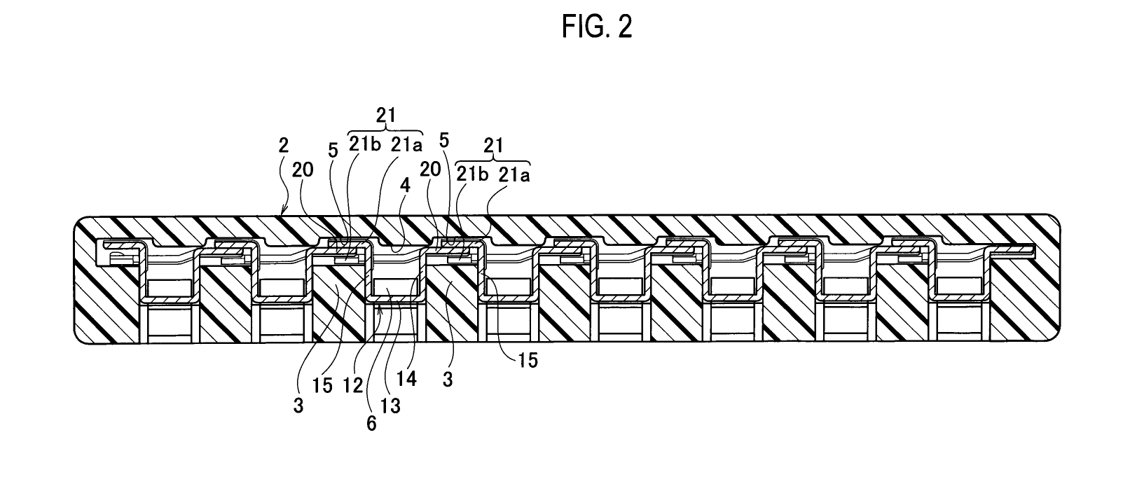

As shown in FIG. 2, the first contact portion 20 and the second contact portion 21 of the joint terminal 10 are located in the adjacent slits 5, respectively. The first contact portion 20 of a joint terminal 10 is inserted into the gap between the upper contact tab 21a and the lower contact tab 21b of the second contact portion 21 of a next joint terminal 60 so as to contact with the lower contact tab 21b of the second contact portion 21. Therefore, the two joint terminals 10 in the neighboring terminal chambers 4 are electrically contacted with each other.

According to the above-explained configuration, an external force(s) F is applies to the sidewalls 14 and 15 as shown in FIG. 4, so that the sidewalls 14 and 15 are bent, at a maximum, until the end edges 16a of the front walls 16 contact with each other. But the sidewalls 14 and 15 are prevented from being bent further. Therefore, the joint terminal 10 can become structurally strong.

In a state where the sidewalls 14 and 15 are bent until the end edges 16a contact with each other, the sidewalls 14 and 15 do not reach to a plastic deformation range, but remain within an elastic deformation range. Namely, a contact position of the end edges 16a is set in the elastic deformation range of the sidewalls 14 and 15. Therefore, the joint terminal 10 can be surely prevented from being bent to its plastic deformation range.

The front walls 16 are formed at the front ends of the sidewalls 14 and 15 by bending portions extended from the front ends of the sidewalls 14 and 15. Therefore, bent borders between the front walls 16 and the sidewalls 14 and 15 have round (curved) shapes. As a result, the joint terminal 10 can be smoothly inserted into the terminal chamber 4.

The supplemental front wall 17 is formed at the front end of the bottom wall 13 of the terminal body 12 by bending a portion extended from the front end of the bottom plate 13. Therefore, a bent border between the supplemental front wall 17 and the bottom wall 13 also has a round (curved) shape. As a result, the joint terminal 10 can be smoothly inserted into the terminal chamber 4.

In addition, the supplemental front wall 17 closes the front area that is not closed by the front walls 16. Therefore, the supplemental front wall 17 prevents a removal tool (not shown) used for removing the joint terminal 10 from the housing 2 from being erroneously inserted into the terminal body 12. Further, as explained above, the supplemental front wall 17 prevents the sidewalls 14 and 15 from being excessively bent by contacting with the front walls 16.

Note that the present invention is not limited to the above-explained embodiment. It is not necessary that the joint terminals 10 must be housed in all of the terminal chambers 4. In this case, one group of the joint terminals 10 and another group of the joint terminals 10 may be electrically separated by a hollow terminal chamber(s) 4. But the joint terminals 10 in the one group (or the other group) can be electrically connected with each other.

What is claimed is:

1. A joint terminal, to be used in a connector housing in a plurality, the terminal comprising:
a wire-crimping portion with which a wire is connected;
a terminal body to be housed in a terminal chamber of the connector housing, the terminal body including a bottom wall and a pair of sidewalls perpendicularly extended from both side ends of the bottom wall, respectively; and
a pair of first and second contact portions laterally extended outward from the pair of sidewalls of the terminal body, respectively, wherein
a pair of front walls is perpendicularly extended from front ends of the sidewalls toward each other so that end edges of the front walls face to each other.

2. The joint terminal according to claim 1, wherein
the front walls are formed at the front ends of the sidewalls by bending portions extended from the front ends of the sidewalls, respectively.

3. The joint terminal according to claim 1, wherein
a supplemental front wall is further formed at a front end of the bottom wall by bending a portion extended from the front end of the bottom wall so that the supplemental front wall closes a front area in a front plane of the terminal body that is not closed by the front walls.

4. A joint connector comprising:
a housing that includes a plurality of terminal chambers segmented by a plurality of partitions; and
at least two neighboring joint terminals that are housed in terminal chambers neighboring among the plurality of terminal chambers, respectively, wherein
each of the neighboring joint terminals includes a wire-crimping portion with which a wire is connected, a terminal body housed in a terminal chamber among the plurality of terminal chambers, and a pair of first and second contact portions laterally extended outward from both sides of the terminal body, respectively,
the each of the neighboring joint terminals includes a bottom wall and a pair of sidewalls perpendicularly extended from both side ends of the bottom wall, respectively, and the pair of first and second contact portions is extended from the sidewalls,
the first contact portion of one of the neighboring joint terminals is electrically contacted with the second contact portion of another of the neighboring joint terminals in a slit among the plurality of slits that is located between the neighboring joint terminals,
a pair of front walls of the each of the neighboring joint terminals is perpendicularly extended from front ends of the sidewalls toward each other so that end edges of the front walls face to each other.

5. The joint connector according to claim 4, wherein, in the each of the neighboring joint terminals,
the front walls are formed at the front ends of the sidewalls by bending portions extended from the front ends of the sidewalls, respectively.

6. The joint connector according to claim 4, wherein, in the each of the neighboring joint terminals,
a supplemental front wall is further formed at a front end of the bottom wall by bending a portion extended from the front end of the bottom wall so that the supplemental front wall closes a front area in a front plane of the terminal body that is not closed by the front walls.
